SEQUENCE LISTING (2 sequences)

SEQ ID NO: 1 - protein, 269 aa, Thermomyces lanuginosus [sequence omitted]

SEQ ID NO: 2 - protein, 544 aa, Geotrichum candidum
QAPTAVLNGNEVISGVLEGKVDTFKGIPFADPPVGDLRFKHPQPFTGSYQGLKANDFSSACMQLDPGNAISLLDKVVGLGKIIPDNLRGPLYDMAQGSVSMNEDCLYLNVFRPAGTKPDAKLPVMVWIYGGAFVFGSSASYPGNGYVKESVEMGQPVVFVSINYRTGPYGFLGGDAITAEGNTNAGLHDQRKGLEWVSDNIANFGGDPDKVMIFGESAGAMSVAHQLVAYGGDNTYNGKQLFHSAILQSGGPLPYFDSTSVGPESAYSRFAQYAGCDASAGDNETLACLRSKSSDVLHSAQNSYDLKDLFGLLPQFLGFGPRPDGNIIPDAAYELYRSGRYAKVPYITGNQEDEGTILAPVAINATTTPHVKKWLKYICSEASDASLDRVLSLYPGSWSEGAPFRTGILNALTPQFKRIAAIFTDLLFQSPRRVMLNATKDVNRWTYLATQLHNLVPFLGTFHGSDLLFQYYVDLGPSSAYRRYFISFANHHDPNVGTNLKQWDMYTDAGREMLQIHMIGNSMRTDDFRIEGISNFESDVTLFG

(19) United States
(12) Patent Application Publication
(10) Pub. No.: US 2026/0152700 A1
(43) Pub. Date: Jun. 4, 2026

(54) LIPID REMOVAL IN DETERGENTS

(71) Applicant: Novozymes A/S, Bagsvaerd (DK)

(72) Inventors: Lone BAUNSGAARD, Helsingoer (DK); Lars ANDERSON, Malmoe (SE); Kim BORCH, Birkeroed (DK)

(73) Assignee: Novozymes A/S, Bagsvaerd (DK)

(21) Appl. No.: 19/122,547

(22) PCT Filed: Oct. 17, 2023
(86) PCT No.: PCT/EP2023/078822

§ 371 Date: Apr. 18, 2025

(30) Foreign Application Priority Data
Oct. 20, 2022 (EP) 22202636.1

(51) Int. Cl. C11D 3/386; C11D 3/20; C11D 3/33; C11D 7/26; C11D 7/32

(52) U.S. Cl. CPC C11D 3/38627; C11D 3/2089; C11D 3/33; C11D 7/263; C11D 7/3254; C11D 2111/12

(57) ABSTRACT

The invention relates to lipid removal enhancers that may be used alone or in concert with lipase in detergents for removal of lipid stains, such as fats and oils, from surfaces, such as textiles, with an increased benefit-risk ratio.

### REFERENCE TO SEQUENCE LISTING

This application contains a Sequence Listing in computer readable form. The computer readable form is incorporated herein by reference.

### FIELD OF THE INVENTION

The present invention relates to detergent compositions comprising compounds capable of lipid removal from laundry during cleaning or washing of laundry.

### BACKGROUND OF THE INVENTION

The ability of a detergent to remove or reduce stains from the surface of textiles is an obvious care-about for the consumer and various surfactant ingredients play a role in that process. However, there is a desire to improve the effect of detergents. Some stains, such as fat (lipid) can be difficult to remove, and traditionally lipases are included to improve fat removal. The potential drawback when using lipases is the formation and release of short-chain fatty acids (e.g., butyric acid and hexanoic acid), leading to malodour perception. This is a potential problem for the consumer who appreciates an increased fat removal but without a corresponding increase in malodour generation. The ratio between lipid removal and malodour generation is called the benefit-risk ratio and in short, an increased benefit-risk ratio is desired. Further, since lipases are proteins there is a risk that they are denatured in compositions comprising high detergent concentrations, such as compact laundry detergent compositions. Additionally, lipases (being proteins) are prone for proteolysis by proteases present in the detergent composition.

WO 2014/095618 (Unilever) discloses a fabric stain-removal composition comprising the combination of one or more enzymes and arginine.

DE1942236 discloses the use of arginine and other amino acids for protein removal of during wash.

None of the prior art discloses laundry detergents comprising lysine, sodium stearoyl lactylate, or esters of lysine or arginine, in particular they do not disclose use of said esters for obtaining an increase in benefit-risk ratio.

### SUMMARY OF THE INVENTION

The inventors of the present invention have surprisingly found a number of lipid removal enhancers that may be used alone or in concert with lipase in detergents for removal of lipid stains, such as fats and oils, from surfaces, such as textiles, with an increased benefit-risk ratio and to a greater extent than arginine. The group of lipid removal enhancers encompassed by the present invention comprises esters of the two amino acids lysine (Lys, K) and arginine (Arg, R), lysine and stearoyl lactylate.

The invention relates to detergent compositions comprising one or more of said lipid removal enhancers. The detergent composition may further comprise a lipase and additional enzymes.

In a further aspect the invention relates to the use of lysine, stearoyl lactylate and said esters of lysine or arginine in detergent composition for the removal of lipid stains, such as fats and oils. Such detergent compositions have several potential advantages, in particular very low odour generation and thereby—also when used in combination with lipases—an increased benefit-risk ratio. Further, they are not susceptible to proteolytic degradation, and less sensitive to high detergent concentration during storage. It is also clear from the experimental data that the lipid removal is maintained at reduced detergent levels leading to less detergent use and improved sustainability.

### Accordingly, the Present Invention Discloses a Detergent Composition Comprising:

a. at least one detergent component;
b. a lipid removal enhancer selected from the group consisting of lysine, stearoyl lactylate, C₁ to C₅ ester of lysine and C₁ to C₅ ester of arginine
c. optionally one or more enzymes.

### Definitions

In accordance with this detailed description, the following definitions apply. Note that the singular forms “a,” “an,” and “the” include plural references unless the context clearly dictates otherwise. Unless defined otherwise or clearly indicated by context, all technical and scientific terms used herein have the same meaning as commonly understood by one of ordinary skill in the art to which this invention belongs.

Unless defined otherwise or clearly indicated by context, all component levels provided herein are made in reference to the active level of that component.

All percentages and ratios of components are calculated by weight unless otherwise indicated. All percentages are calculated based on the total composition unless otherwise indicated.

### Benefit-Risk Ratio

The benefit-risk ratio (B/R ratio) is the ratio between lipid removal and malodour generation, where malodour generation is measured as amount of butyric acid released from CS-10 swatches washed under the same conditions as the textile with lipid stain.

C₁-C₅ Esters of Lysine and Arginine

Esters of lysine and arginine are derivatives of the two amino acids where the —OH group of the C-terminal carboxyl group has been replaced by —OR group, wherein R is an alkyl or aryl comprising one to five carbon atoms. Preferably R is an alkyl comprising one to five carbon atoms, said alkyl group may be linear or branched.

### Detergent Component

The term “detergent component” means a detergent adjunct ingredient that is different from the lipid removal enhancer of this invention. The precise nature of these additional cleaning or adjunct components, and levels of incorporation thereof, will depend on the physical form of the composition and the nature of the operation for which it is to be used. Suitable detergent components include, but are not limited to the components described below, such as surfactants, builders and co-builders, flocculating aid, chelating agents, dye transfer inhibitors, enzymes (other than the enzymes of the invention), enzyme stabilizers, enzyme inhibitors, catalytic materials, bleach activators, hydrogen peroxide, sources of hydrogen peroxide, preformed peracids, polymeric agents, clay soil removal/anti-redeposition agents, brighteners, suds suppressors, dyes, perfumes, structure elasticizing agents, fabric softeners, carriers, hydrotropes, fabric hueing agents, anti-foaming agents, dispersants, processing aids, and/or pigments. Detergent compositions will typically contain at least one surfactant along with additional components such as at least one builder and/or at least one bleach component

### Detergent Composition

The term “detergent composition” refers to compositions that find use in the removal of undesired compounds from items to be cleaned, such as textiles, dishes, and hard surfaces. The detergent composition may be used to e.g. clean textiles, dishes and hard surfaces for both household cleaning and industrial cleaning and/or for fabric care. The terms encompass any materials/compounds selected for the particular type of cleaning composition desired and the form of the product (e.g., liquid, gel, powder, granulate, paste, or spray compositions) and includes, but is not limited to, detergent compositions (e.g., liquid and/or solid laundry detergents and fine fabric detergents; hard surface cleaning formulations, such as for glass, wood, plastic, ceramic and metal counter tops and windows; carpet cleaners; oven cleaners; fabric fresheners; fabric softeners; and textile and laundry pre-spotters, as well as dish wash detergents). In addition to containing a lipid removal enhancer the invention, the detergent formulation may contain one or more additional enzymes (such as amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases (GH5 and/or GH26), licheninases, phosphodiesterases, pectin methylesterases, cellobiohydrolases, transglutaminases, nucleases, and combinations thereof, or any mixture thereof), and/or detergent components such as surfactants, hydrotropes, builders, co-builders, chelators or chelating agents, bleaching system or bleach components, polymers, fabric hueing agents, fabric conditioners, foam boosters, suds suppressors, dispersants, dye transfer inhibitors, fluorescent whitening agents, perfume, tannish inhibitors, optical brighteners, bactericides, fungicides, soil suspending agents, soil release polymers, anti-redeposition agents, enzyme inhibitors or stabilizers, enzyme activators, antioxidants, and solubilizers. The detergent composition may comprise of one or more of any type of detergent component. In particular the detergent composition may be suitable for use in domestic or industrial laundry, i.e., a laundry detergent. Reference is made to the paragraph Detergent compositions for further details.

### Improved Wash Performance

The term “improved wash performance” is defined herein as a compound (lipid removal enhancer or lipase or combination thereof) displaying an increased wash performance in a detergent composition relative to the wash performance of a reference.

### Laundry:

The term includes according to the invention textiles, clothes, linen and the like and may be made from any material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polyamides including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well. In the context of the present invention, the term “laundry” also covers fabrics.

### Lipase:

The terms “lipase”, “lipase enzyme”, “lipolytic enzyme”, “lipid esterase”, “lipolytic polypeptide”, and “lipolytic protein” refers to an enzyme in class EC3.1.1 as defined by Enzyme Nomenclature. It may have lipase activity (triacylglycerol lipase, EC3.1.1.3), cutinase activity (EC3.1.1.74), sterol esterase activity (EC3.1.1.13) and/or wax-ester hydrolase activity (EC3.1.1.50). For purposes of the present invention lipase activity (i.e. the hydrolytic activity of the lipase) may be determined with a pNP assay using substrates with various chain length as described in Experimental.

### Lipid:

Lipids are fatty, waxy or oily compounds that are insoluble in polar solvents, such as water. Lipids include fats (e.g. lard) and oils.

### Lipid Removal Enhancer:

In context of the present invention, a lipid removal enhancer refers to a non-enzymatic compound which enhances the removal of lipid, either when the lipid removal enhancer is used alone or when used in combination with a lipase. The effect of the lipid removal enhancer is the greater removal of lipid compared to when the lipid removal enhancer is not present at the same test conditions. The performance may, according to the present invention, be determined as percent (%) fat removal as described in the Examples.

### Malodour

Malodour (or odour) is measured as amount of butyric acid released from CS-10 swatches.

### Sequence Identity

The relatedness between two amino acid sequences is described by the parameter “sequence identity”. For purposes of the present invention, the sequence identity between two amino acid sequences is determined using the Needleman-Wunsch algorithm (Needleman and Wunsch, 1970, J. Mol. Biol. 48:443-453) as implemented in the Needle program of the EMBOSS package (EMBOSS: The European Molecular Biology Open Software Suite, Rice et al., 2000, Trends Genet. 16:276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

### Textile

The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and towelling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used, it is intended to include the broader term textiles as well.

### Variant

The term “variant” means a polypeptide having lipase activity comprising single or multiple amino acid substitutions, deletions, and/or insertions at one or more (e.g., several) positions in parent lipase.

### Wash Liquor

The term “wash liquor” refers to an aqueous solution containing a detergent composition in dilute form, such as but not limited to a detergent solution containing a laundry detergent composition in dilute form such as the wash liquor in a laundry process.

Wash performance: The ability to remove or reduce stains from laundry, in particular lipid stains.

### DETAILED DESCRIPTION OF THE INVENTION

The present invention relates to the use of lipid removal enhancers in detergents, in particular in laundry detergents. The lipid removal enhancers are selected from the group consisting of lysine, stearoyl lactylate and esters of lysine or arginine. Further aspect of the invention is the use of said lipid removal enhancers in a detergent composition for the removal of lipid stains, such as fats and oils, in particular removal of lipid stains on textile.

Stearoyl lactylate may be used in any available form, but preferred forms are non-toxic salts of stearoyl lactylate, such as sodium stearoyl lactylate (SLS).

Lysine and arginine can both be found in two stereoisomeric forms termed D and L. In the context of the present invention both the D and the L form is encompassed when reference is made to the lysine and arginine as well as the esters of the amino acids. Mixtures of the two isomeric forms in any ratio is also encompassed by the invention.

Preferred esters of lysine for the use as lipid removal enhancers are C₁ to C₅ esters of lysine comprising methyl, ethyl, 1-propyl, 2-propyl, 1-butyl, 2-butyl, 2-methyl-2-propyl, 2-methylpropyl, pentyl, 1,1-dimethylpropyl, 2,2-dimethylpropyl, 3-methylbutyl, 1-methylbutyl, 1-ethylpropyl, 1,2-methylpropyl and 2-methylbutyl.

Preferred esters of arginine for the use as lipid removal enhancers are C₁ to C₅ esters of arginine comprising is methyl, ethyl, 1-propyl, 2-propyl, 1-butyl, 2-butyl, 2-methyl-2-propyl, 2-methylpropyl, pentyl, 1,1-dimethylpropyl, 2,2-dimethylpropyl, 3-methylbutyl, 1-methylbutyl, 1-ethylpropyl, 1,2-methylpropyl and 2-methylbutyl.

The concentration of lipid removal enhancers in the detergent is preferably adjusted in such way that the final concentration in the wash liquor is in the range of 0.5 mM to 20 mM for lysine and esters of lysine and arginine. In a preferred embodiment the final concentration in the wash liquor is in the range of 1 mM to 10 mM for lysine and esters of lysine and arginine.

The concentration of stearoyl lactylate in the detergent is preferably adjusted in such way that the final concentration in the wash liquor corresponds to sodium stearoyl lactylate in the range of 100 ppm to 400 ppm. In a preferred embodiment the final concentration in the wash liquor corresponds to sodium stearoyl lactylate in the range of 100 ppm to 300 ppm.

The use of lipid removal enhancers has the effect that lipid stains are removed or reduced from textile during laundering (benefit) with only little generation of malodour (risk). The ratio between lipid removal and malodour generation is known as the benefit-risk ratio and both lipid removal and malodour generation may be measured as disclosed in the paragraph Experimental.

In the context of the present invention the malodour is reduced with at least a factor 5, such as in the range 5-50, preferably at least a factor 10, 15 or even 20, compared to the use of lipase when at least the same level of lipid removal (measured as oil or lard removal) is obtained. It follows that the benefit-risk ratio is improved by at least the same factor.

Dosage of the lipase depends on the actual lipase dosed, but typically lipase is dosed in the range 0.1 ppm to 5 ppm (enzyme protein), preferably the lipase is dosed in the range 0.1 ppm to 0.4 ppm (enzyme protein).

The lipid removal enhancer may be used in combination with enzymes in the detergent, such as amylases, proteases, peroxidases, cellulases, betaglucanases, xyloglucanases, hemicellulases, xanthanases, xanthan lyases, lipases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases (GH5 and/or GH26), licheninases, phosphodiesterases, pectin methylesterases, cellobiohydrolases, transglutaminases, nucleases, and combinations thereof.

In particular, the lipid removal enhancer may be used in combination with lipase or cutinase for lipid removal. Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157), S. pristinaespiralis (WO12/137147) and Pseudomonas mendocina (WO 2022/197810). Further, lipases from Geotrichum candidum as disclosed in WO2022/162043 may be useful.

When enzymes are present together with the lipid removal enhancer, the enzymes are present in an amount selected from the group consisting of 0.002 to 10,000 mg of enzyme protein, 0.005 to 5,000 mg of enzyme protein, 0.01 to 5,000 mg of enzyme protein, 0.05 to 5,000 mg of enzyme protein, 0.05 to 1,500 mg of enzyme protein, 0.1 to 1,000 mg of enzyme protein, 0.1 to 500 mg of enzyme protein, and 0.1 to 100 mg of enzyme protein, per litre of wash liquor.

### Detergent Compositions

In one embodiment, the invention is directed to detergent compositions comprising a lipid removal enhancer of the present invention in combination with one or more additional cleaning composition components. The choice of additional components is within the skill of the artisan and includes conventional ingredients, including the exemplary non-limiting components set forth below. Additional, optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in laundry detergents may be utilized. The choice of such ingredients is well within the skill of the artisan.

The choice of components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

In one embodiment, the invention is directed to a liquid laundry detergent composition comprising a lipid removal enhancer the present invention in combination with one or more additional laundry detergent composition components, specifically a protease. In another embodiment, the invention comprises an ancillary product used in laundry, such as a prespotter or stain removal booster. The present invention also relates to an ADW (Automatic Dish Wash) compositions comprising a lipid removal enhancer of the present invention in combination with one or more additional ADW composition components. The choice of additional components is within the skill of the artisan and includes conventional ingredients, including the exemplary non-limiting components set forth below.

The concentration of detergent in the wash liquor may be adjusted to according to regional requirements (e.g. water hardness) and wash load, but is typically in the range of 0.5 g/L wash liquor to 5 g/L wash liquor, particularly in the range of 0.5 g/L wash liquor to 2.5 g/L wash liquor, with a tendency that detergent compositions become more compact and thus lower amount of detergent per liter of wash liquor is required.

### Surfactants

Typically, the detergent composition comprises (by weight of the composition) one or more surfactants in the range of 0% to 50%, preferably from 2% to 40%, more preferably from 5% to 35%, more preferably from 7% to 30%, most preferably from 10% to 25%, even most preferably from 15% to 20%. In a preferred embodiment the detergent is a liquid or powder detergent comprising less than 40%, preferably less than 30%, more preferably less than 25%, even more preferably less than 20% by weight of surfactant. The composition may comprise from 1% to 15%, preferably from 2% to 12%, 3% to 10%, most preferably from 4% to 8%, even most preferably from 4% to 6% of one or more surfactants. Preferred surfactants are anionic surfactants, non-ionic surfactants, cationic surfactants, zwitterionic surfactants, amphoteric surfactants, and mixtures thereof. Suitable anionic surfactants are well known in the art and may comprise fatty acid carboxylates (soap), branched-chain, linear-chain and random chain alkyl sulfates or fatty alcohol sulfates or primary alcohol sulfates or alkyl benzenesulfonates such as LAS and LAB or phenylalkanesulfonates or alkenyl sulfonates or alkenyl benzenesulfonates or alkyl ethoxysulfates or fatty alcohol ether sulfates or alpha-olefin sulfonate or dodecenyl/tetradecenylsuccinic acid. The anionic surfactants may be alkoxylated. The detergent composition may also comprise from 1 wt % to 10 wt % of non-ionic surfactant, preferably from 2 wt % to 8 wt %, more preferably from 3 wt % to 7 wt %, even more preferably less than 5 wt % of non-ionic surfactant. Suitable non-ionic surfactants are well known in the art and may comprise alcohol ethoxylates, and/or alkyl ethoxylates, and/or alkylphenol ethoxylates, and/or glucamides such as fatty acid N-glucosyl N-methyl amides, and/or alkyl polyglucosides and/or mono- or diethanolamides or fatty acid amides. The detergent composition may also comprise from 0 wt % to 10 wt % of cationic surfactant, preferably from 0.1 wt % to 8 wt %, more preferably from 0.5 wt % to 7 wt %, even more preferably less than 5 wt % of cationic surfactant. Suitable cationic surfactants are well known in the art and may comprise alkyl quaternary ammonium compounds, and/or alkyl pyridinium compounds and/or alkyl quaternary phosphonium compounds and/or alkyl ternary sulphonium compounds. The composition preferably comprises surfactant in an amount to provide from 100 ppm to 5,000 ppm surfactant in the wash liquor during the laundering process. The composition upon contact with water typically forms a wash liquor comprising from 0.5 g/l to 10 g/l detergent composition. Many suitable surface active compounds are available and fully described in the literature, for example, in “Surface-Active Agents and Detergents”, Volumes I and 11, by Schwartz, Perry and Berch. Also preferred are biobased surfactants, which may be wholly biobased (>95% biobased carbon of total carbon according to European standard EN 17035). As used herein biobased surfactants are a commercial or industrial product (other than food or feed) that is composed, in whole or in significant part, of biological products or renewable agricultural materials or forestry materials and/or as established by European standard EN 16575:2014. In particular rhamnolipids and sophorolipids may be used a detergent ingredient.

### Solvent System

For dissolution of the surfactant and other detergent ingredients, a solvent system is needed. Solvents are typically water, alcohols, polyols, sugars and/or mixtures thereof. Preferred solvents are water, glycerol, sorbitol, propylene glycol (MPG, 1,2-propanediol or 1,3-propane diol), dipropylene glycol (DPG), polyethylene glycol family (PEG300-600), hexylene glycol, inositol, mannitol, Ethanol, isopropanol, n-butoxy propoxy propanol, ethanolamines (monoethanol amine, diethanol amines and triethanol amines), sucrose, dextrose, glucose, ribose, xylose, and related mono and di pyranosides and furanosides. The solvent system is present in typically totally 5-90%, 5-60%, 5-40%, 10-30% by weight.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants), however the molecular structure of hydrotropes generally do not favor spontaneous self-aggregation, see e.g., review by Hodgdon and Kaler (2007), Current Opinion in Colloid & Interface Science 12:121-128. The detergent may contain 0-10% by weight, for example 0-5% by weight, such as about 0.5 to about 5%, or about 3% to about 5%, of a hydrotrope.

### Builders and Co-Builders

The detergent composition may contain about 0-65%, 0-20%; or 0.5-5% of a detergent builder or co-builder, or a mixture thereof. In a dish wash detergent, the level of builder is typically 10-65%, particularly 20-40%. The builder and/or co-builder may particularly be a chelating agent that forms water-soluble complexes with Ca and Mg. Any builder and/or co-builder known in the art for use in laundry detergents may be utilized.

### Bleaching Systems

The detergent may contain 0-30% by weight, such as about 1% to about 20%, of a bleaching system. Any bleaching system known in the art for use in laundry detergents may be utilized.

### Polymers

The detergent may contain 0-10% by weight, such as 0.5-5%, 2-5%, 0.5-2% or 0.2-1% of a polymer. Any polymer known in the art for use in detergents may be utilized. The polymer may function as a co-builder as mentioned above, or may provide antiredeposition, fiber protection, soil release, dye transfer inhibition, grease cleaning and/or anti-foaming properties. Some polymers may have more than one of the above-mentioned properties and/or more than one of the below-mentioned motifs.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light.

### Dispersants

The detergent compositions of the present invention can also contain dispersants. In particular powdered detergents may comprise dispersants. Suitable water-soluble organic materials include the homo- or co-polymeric acids or their salts, in which the polycarboxylic acid comprises at least two carboxyl radicals separated from each other by not more than two carbon atoms. Suitable dispersants are for example described in Powdered Detergents, Surfactant science series volume 71, Marcel Dekker, Inc.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalate based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore random graft co-polymers are suitable soil release polymers. Suitable graft co-polymers are described in more detail in WO 2007/138054, WO 2006/108856 and WO 2006/113314 (hereby incorporated by reference). Other soil release polymers are substituted polysaccharide structures especially substituted cellulosic structures such as modified cellulose deriviatives such as those described in EP 1867808 or WO 2003/040279 (both are hereby incorporated by reference). Suitable cellulosic polymers include cellulose, cellulose ethers, cellulose esters, cellulose amides and mixtures thereof. Suitable cellulosic polymers include anionically modified cellulose, nonionically modified cellulose, cationically modified cellulose, zwitterionically modified cellulose, and mixtures thereof. Suitable cellulosic polymers include methyl cellulose, carboxy methyl cellulose, ethyl cellulose, hydroxyl ethyl cellulose, hydroxyl propyl methyl cellulose, ester carboxy methyl cellulose, and mixtures thereof.

### Anti-Redeposition Agents

The detergent compositions of the present invention may also include one or more anti-redeposition agents such as carboxymethylcellulose (CMC), polyvinyl alcohol (PVA), polyvinylpyrrolidone (PVP), polyoxyethylene and/or polyethyleneglycol (PEG), homopolymers of acrylic acid, copolymers of acrylic acid and maleic acid, and ethoxylated polyethyleneimines. The cellulose based polymers described under soil release polymers above may also function as anti-redeposition agents.

### Rheology Modifiers

Rheology modifiers are structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

### Other Suitable Adjunct Materials

Other adjunct materials include, but are not limited to, anti-shrink agents, anti-wrinkling agents, bactericides, binders, carriers, dyes, enzyme stabilizers, fabric softeners, fillers, foam regulators, perfumes, pigments and sod suppressors.

### Additional Enzymes

The detergent additive as well as the detergent composition may comprise one or more [additional] enzymes such as hydrolases (EC 3.-.-.-) such as hydrolases acting on ester bonds (EC 3.1.-.-), glycosidases (EC 3.2.-.-), and hydrolases acting on peptide bonds (EC 3.4.-.-), oxidoreductases (EC 1.-.-.-) such as laccases (EC 1.10.-.-) or peroxidases (EC 1.11.-.-) or lyases (EC 4.-.-.-) such as carbon-oxygen lyases (EC 4.2.-.-). In a specific embodiment the detergent composition may comprise one or more enzymes such as a protease, lipase, cutinase, an amylase, carbohydrase, cellulase, pectinase, mannanase, arabinase, galactanase, xylanase, oxidase, e.g., a laccase, and/or peroxidase.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### Cellulases

Suitable additional cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and WO 89/09259.

### Mannanases

Mannanases have mannan endo-1,4-beta-mannosidase activity (EC 3.2.1.78) that catalyzes the hydrolysis of 1,4-beta-D-mannosidic linkages in mannans, galactomannans and glucomannans. According to CAZy (www.cazy.org), endo-1,4-beta-mannanases have been found in glycoside hydrolyase families 5, 26 and 113. Suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S).

### Proteases

Proteases are enzymes that hydrolyses peptide bonds. It includes any enzyme belonging to the EC 3.4 enzyme group (including each of the thirteen subclasses thereof (http://en.wikipedia.org/wiki/Category: EC_3.4). The EC number refers to Enzyme Nomenclature 1992 from NC-IUBMB, Academic Press, San Diego, California, including supplements 1-5 published in Eur. J. Biochem. 1994, 223, 1-5; Eur. J. Biochem. 1995, 232, 1-6; Eur. J. Biochem. 1996, 237, 1-5; Eur. J. Biochem. 1997, 250, 1-6; and Eur. J. Biochem. 1999, 264, 610-650; respectively. The term “subtilases” refer to a sub-group of serine protease according to Siezen et al., Protein Eng. 4 (1991) 719-737 and Siezen et al. Protein Science 6 (1997) 501-523. Serine proteases or serine peptidases is a subgroup of proteases characterized by having a serine in the active site, which forms a covalent adduct with the substrate. Further, the subtilases (and the serine proteases) are characterized by having two active site amino acid residues apart from the serine, namely a histidine and an aspartic acid residue. The subtilases may be divided into six sub-divisions, i.e. the Subtilisin family, the Thermitase family, the Proteinase K family, the Lantibiotic peptidase family, the Kexin family and the Pyrolysine family. The term “protease activity” means a proteolytic activity (EC 3.4).

Suitable proteases include those of bacterial, fungal, plant, viral or animal origin e.g. vegetable or microbial origin. Microbial origin is preferred. Chemically modified or protein engineered mutants are included. It may be an alkaline protease, such as a serine protease or a metalloprotease. A serine protease may for example be of the S1 family, such as trypsin, or the S8 family such as subtilisin. A metalloproteases protease may for example be a thermolysin from e.g. family M4 or other metalloprotease such as those from M5, M7 or M8 families.

### Lipases and Cutinases:

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147). Further, lipases from Geotrichum candidum as disclosed in WO2022/162043 may be useful.

### Amylases:

Suitable amylases which can be used together with the endoglucanases of the invention may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

### Peroxidases/Oxidases:

A peroxidase is a peroxidase enzyme comprised by the enzyme classification EC 1.11.1.7, as set out by the Nomenclature Committee of the International Union of Biochemistry and Molecular Biology (IUBMB), or any fragment derived therefrom, exhibiting peroxidase activity.

Suitable peroxidases include those of plant, bacterial or fungal origin. Chemically modified or protein engineered mutants are included. Examples of useful peroxidases include peroxidases from Coprinopsis, e.g., from C. cinerea (EP 179,486), and variants thereof as those described in WO 93/24618, WO 95/10602, and WO 98/15257.

### Nucleases

Suitable nucleases include deoxyribonucleases (DNases) and ribonucleases (RNases) which are any enzyme that catalyzes the hydrolytic cleavage of phosphodiester linkages in the DNA or RNA backbone respectively, thus degrading DNA and RNA. Preferred DNases may be selected from any of the enzyme classes E.C. 3.1.21.X, where X=1, 2, 3, 4, 5, 6, 7, 8 or 9.

The DNase polypeptide is typically a microbial enzyme, preferably of fungal or bacterial origin, or a genetically engineered variant of a microbial DNase.

### Licheninases

Suitable licheninases (lichenase) include enzymes that catalyse the hydrolysis of the beta-1,4-glucosidic bonds to give beta-glucans. Licheninases (or lichenases) (e.g. EC 3.2.1.73) hydrolyse (1,4)-beta-D-glucosidic linkages in beta-D-glucans containing (1,3)- and (1,4)-bonds and can act on lichenin and cereal beta-D-glucans.

### Xanthanases

Xanthan gum is a natural polysaccharide consisting of different sugars which are connected by several different bonds, such as b-D-mannosyl-b-D-1,4-glucuronosyl bonds and b-D-glucosyl-b-D-1,4-glucosyl bonds. Xanthan gum is at least partly soluble in water and forms highly viscous solutions or gels. Complete enzymatic degradation of xanthan gum requires several enzymatic activities including xanthan lyase activity and endo-beta-1,4-glucanase activity, preferably a GH9 endoglucanase. Xanthan lyases are enzymes that cleave the b-D-mannosyl-b-D-1,4-glucuronosyl bond of xanthan, whereas the GH9 endoglucanase catalyses the hydrolysis of the glycosyl bond to release smaller sugars.

### Enzyme Formulations

### Liquid Enzyme Formulations

The lipid removal enhancer of the present invention may be formulated as a liquid enzyme formulation, which is generally a pourable composition, though it may also have a high viscosity. The physical appearance and properties of a liquid enzyme formulation may vary a lot 13 for example, they may have different viscosities (gel to water-like), be colored, not colored, clear, hazy, and even with solid particles like in slurries and suspensions. The minimum ingredients are the lipid removal enhancer of the present invention and a solvent system to make it a liquid. In addition to the lipid removal enhancer of the present invention, the liquid enzyme formulation may also comprise other enzyme activities, such as protease, amylase, lipase, cellulase, and/or nuclease (e.g., DNase, RNase) activities.

The solvent system may comprise water, polyols (such as glycerol, (mono, di, or tri) propylene glycol, (mono, di, or tri) ethylene glycol, sugar alcohol (e.g. sorbitol, mannitol, erythritol, dulcitol, inositol, xylitol or adonitol), polypropylene glycol, and/or polyethylene glycol), ethanol, sugars, and salts. Usually the solvent system also includes a preservation agent and/or other stabilizing agents.

A liquid enzyme formulation may be prepared by mixing a solvent system and an enzyme concentrate with a desired degree of purity (or enzyme particles to obtain a slurry/suspension).

In an embodiment, the liquid enzyme composition comprises:
(a) at least 0.01% w/w active enzyme protein,
(b) at least 0.5% w/w polyol,
(c) water, and
(d) optionally a preservation agent.

The lipid removal enhancer of the present invention in the liquid composition of the invention may be stabilized using conventional stabilizing agents. Examples of stabilizing agents include, but are not limited to, sugars like glucose, fructose, sucrose, or trehalose; addition of salt to increase the ionic strength; divalent cations (e.g., Ca²⁺ or Mg²⁺); and enzyme inhibitors, enzyme substrates, or various polymers (e.g., PVP). Selecting the optimal pH for the formulation may be very important for enzyme stability. The optimal pH depends on the specific enzyme but is typically in the range of pH 4-9. In some cases, surfactants like nonionic surfactant (e.g., alcohol ethoxylates) can improve the physical stability of the enzyme formulations.

One embodiment of the invention relates to a composition comprising a lipid removal enhancer of the present invention, wherein the composition further comprises:
(i) a polyol, preferably selected from glycerol, (mono, di, or tri) propylene glycol, (mono, di, or tri) ethylene glycol, polyethylene glycol, sugar alcohols, sorbitol, mannitol, erythritol, dulcitol, inositol, xylitol and adonitol;
(ii) optionally an additional enzyme, preferably selected from protease, amylase, or lipase,
(iii) optionally a surfactant, preferably selected from anionic and nonionic surfactants,
(iv) optionally a divalent cation, polymer, or enzyme inhibitor.
(v) optionally having a pH in the range of pH 4-9; and
(vi) water.

Slurries or dispersions of enzymes are typically prepared by dispersing small particles of enzymes (e.g., spray-dried particles) in a liquid medium in which the enzyme is sparingly soluble, e.g., a liquid nonionic surfactant or a liquid polyethylene glycol. Powder can also be added to aqueous systems in an amount so not all go into solution (above the solubility limit). Another format is crystal suspensions which can also be aqueous liquids (see for example WO2019/002356). Another way to prepare such dispersion is by preparing water-in-oil emulsions, where the enzyme is in the water phase, and evaporate the water from the droplets. Such slurries/suspension can be physically stabilized (to reduce or avoid sedimentation) by addition of rheology modifiers, such as fumed silica or xanthan gum, typically to get a shear thinning rheology.

### Granular Enzyme Formulations

The lipid removal enhancer of the present invention may also be formulated together with enzymes as a solid/granular enzyme formulation. Non-dusting granulates may be produced, e.g. as disclosed in U.S. Pat. Nos. 4,106,991 and 4,661,452, and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591.

The lipid removal enhancer of the present invention may be formulated as a granule for example as a co-granule that combines the lipid removal enhancer with enzymes or benefit agents (such as MnTACN or other bleaching components). Examples of such additional enzymes include proteases, amylases, lipases, cellulases, and/or nucleases (e.g., DNase, RNase). Each enzyme will then be present in more granules securing a more uniform distribution of enzymes in the detergent. This also reduces the physical segregation of different enzymes due to different particle sizes. Methods for producing multi-enzyme co-granulate for the detergent industry are disclosed in the IP.com disclosure IPCOM000200739D.

An embodiment of the invention relates to an enzyme granule/particle comprising a lipid removal enhancer of the present invention. The granule is composed of a core, and optionally one or more coatings (outer layers) surrounding the core. Typically, the granule/particle size, measured as equivalent spherical diameter (volume based average particle size), of the granule is 20-2000 μm, particularly 50-1500 μm, 100-1500 μm or 250-1200 μm.

The core may include additional materials such as fillers, fibre materials (cellulose or synthetic fibres), stabilizing agents, solubilising agents, suspension agents, viscosity regulating agents, light spheres, plasticizers, salts, lubricants and fragrances. The core may include binders, such as synthetic polymer, wax, fat, or carbohydrate. The core may comprise a salt of a multivalent cation, a reducing agent, an antioxidant, a peroxide decomposing catalyst and/or an acidic buffer component, typically as a homogenous blend. The core may consist of an inert particle with the enzyme absorbed into it, or applied onto the surface, e.g., by fluid bed coating. The core may have a diameter of 20-2000 μm, particularly 50-1500 μm, 100-1500 μm or 250-1200 μm. The core can be prepared by granulating a blend of the ingredients, e.g., by a method comprising granulation techniques such as crystallization, precipitation, pan-coating, fluid bed coating, fluid bed agglomeration, rotary atomization, extrusion, prilling, spheronization, size reduction methods, drum granulation, and/or high shear granulation. Methods for preparing the core can be found in Handbook of Powder Technology; Particle size enlargement by C. E. Capes; Volume 1; 1980; Elsevier. These methods are well-known in the art and have also been described in international patent application WO2015/028567, pages 3-5, which is incorporated by reference.

The core of the enzyme granule/particle may be surrounded by at least one coating, e.g., to improve the storage stability, to reduce dust formation during handling, or for coloring the granule. The optional coating(s) may include a salt coating, or other suitable coating materials, such as polyethylene glycol (PEG), methyl hydroxy-propyl cellulose (MHPC) and polyvinyl alcohol (PVA). Examples of enzyme granules with multiple coatings are shown in WO 93/07263 and WO 97/23606.

Such coatings are well-known in the art, and have earlier been described in, for example, WO00/01793, WO2001/025412, and WO2015/028567, which are incorporated by reference.

In One aspect, the present invention provides a granule, which comprises:
(a) a core comprising a lipid removal enhancer of the present invention and optionally one or more enzymes; and
(b) optionally a (salt) coating consisting of one or more layer(s) surrounding the core.

Another aspect of the invention relates to a layered granule, comprising:
(a) a (non-enzymatic) core;
(b) a coating surrounding the core, wherein the coating comprises an enzyme;
(c) optionally a (salt) coating consisting of one or more layer(s) surrounding the enzyme containing coating; and
(d) a lipid removal enhancer of the present invention in any of (a) to (c) above.

### Encapsulated Enzyme Formulations

The lipid removal enhancer of the present invention may also be formulated as part of an encapsulated enzyme formulation (an ‘encapsulate’). This is particularly useful for separating the enzyme from other ingredients when the enzyme is added into, for example, a (liquid) cleaning composition, such as the detergent compositions described below.

Physical separation can be used to solve incompatibility between the enzyme(s) and other components. Incompatibility can arise if the other components are either reactive against the enzyme, or if the other components are substrates of the enzyme. Other enzymes can be substrates of proteases.

The enzyme may be encapsulated in a matrix, preferably a water-soluble or water dispersible matrix (e.g., water-soluble polymer particles), for example as described in WO 2016/023685. An example of a water-soluble polymeric matrix is a matrix composition comprising polyvinyl alcohol. Such compositions are also used for encapsulating detergent compositions in unit-dose formats.

The enzyme may also be encapsulated in core-shell microcapsules, for example as described in WO 2015/144784, or as described in the IP.com disclosure IPCOM000239419D.

Such core-shell capsules can be prepared using a number of technologies known in the art, e.g., by interfacial polymerization using either a water-in-oil or an oil-in-water emulsion, where polymers are crosslinked at the surface of the droplets in the emulsion (the interface between water and oil), thus forming a wall/membrane around each droplet/capsule.

Unit-dose detergents is a common terminology covering detergents delivered in single-use format; these can be pouches of poly(vinyl alcohol) containing liquid detergents or powder detergents in single or multiple chambers with either all liquid chambers or hybrid models with both liquid and powder chambers. Unit-dose detergents can also be pressed tablets with one or more layers (‘phases’). Laundry unit-dose liquid compositions are generally low in water (<10% w/w); high in surfactants (50 to 65%), high in solvents (15 to 30% polyols) relative to typical mass fraction levels in aqueous HDL.

### Purity of Enzyme in Formulations

The enzyme used in the above-mentioned enzyme formulations may be purified to any desired degree of purity. This includes high levels of purification, as achieved for example by using methods of crystallization—but also none or low levels of purification, as achieved for example by using crude fermentation broth, as described in WO 2001/025411, or in WO 2009/152176.

### Formulation of Detergent Products

The detergent composition of the invention may be in any convenient form, e.g., a bar, a homogenous tablet, a tablet having two or more layers, a pouch having one or more compartments, a regular or compact powder, a granule, a paste, a gel, or a regular, compact or concentrated liquid.

The detergent enzyme(s) may be included in a detergent composition by adding separate additives containing one or more enzymes, or by adding a combined additive comprising all of these enzymes. A detergent additive of the invention, i.e., a separate additive or a combined additive, can be formulated, for example, as a granulate, liquid, slurry, etc. Preferred detergent additive formulations are granulates, in particular non-dusting granulates, liquids, in particular stabilized liquids and, or slurries.

Non-dusting granulates may be produced, e.g. as disclosed in U.S. Pat. Nos. 4,106,991 and 4,661,452 and may optionally be coated by methods known in the art. Examples of waxy coating materials are poly(ethylene oxide) products (polyethyleneglycol, PEG) with mean molar weights of 1000 to 20000; ethoxylated nonylphenols having from 16 to 50 ethylene oxide units; ethoxylated fatty alcohols in which the alcohol contains from 12 to 20 carbon atoms and in which there are 15 to 80 ethylene oxide units; fatty alcohols; fatty acids; and mono- and di- and triglycerides of fatty acids. Examples of film-forming coating materials suitable for application by fluid bed techniques are given in GB 1483591. Liquid enzyme preparations may, for instance, be stabilized by adding a polyol such as propylene glycol, a sugar or sugar alcohol, lactic acid or boric acid according to established methods. Protected enzymes may be prepared according to the method disclosed in EP 238,216.

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be of blended compositions comprising hydrolytically degradable and water-soluble polymer blends such as polylactide and polyvinyl alcohol (known under the Trade reference M8630 as sold by MonoSol LLC, Indiana, USA) plus plasticisers like glycerol, ethylene glycerol, propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids. Ref: (US2009/0011970 A1). Detergent ingredients can be separated physically from each other by compartments in water dissolvable pouches or in different layers of tablets. Thereby negative storage interaction between components can be avoided. Different dissolution profiles of each of the compartments can also give rise to delayed dissolution of selected components in the wash solution.

A liquid or gel detergent, which is not unit dosed, may be aqueous, typically containing at least 20% by weight and up to 95% water, such as up to about 70% water, up to about 65% water, up to about 55% water, up to about 45% water, up to about 35% water. Other types of liquids, including without limitation, alkanols, amines, diols, ethers and polyols may be included in an aqueous liquid or gel. An aqueous liquid or gel detergent may contain from 0-30% organic solvent. A liquid or gel detergent may be non-aqueous.

### Use in Detergents.

The lipid removal enhancer of the present invention may be added to and thus become a component of a detergent composition.

The detergent composition of the present invention may be formulated, for example, as a hand or machine laundry detergent composition including a laundry additive composition suitable for pre-treatment of stained fabrics or for rejuvenating textile (e.g. by fuzz or pill removal) to restore some of the visual and feel properties of fabrics after extended use to match that of a new textile, and a rinse added fabric softener composition, or be formulated as a detergent composition for use in general household hard surface cleaning operations, or be formulated for hand or machine dishwashing operations.

In a specific aspect, the present invention provides a detergent additive comprising a lipid removal enhancer of the present invention as described herein.

### Embodiments

The invention is further described in the following embodiments:
1) A detergent composition comprising:
   a. at least one detergent component;
   b. a lipid removal enhancer selected from the group consisting of lysine, stearoyl lactylate, C₁ to C₅ ester of lysine and C₁ to C₅ ester of arginine
   c. optionally one or more enzymes.
2) The composition according to embodiment 1, wherein the composition is a laundry detergent composition.
3) The composition according to embodiment 1 (b), wherein the lipid removal enhancer is selected from the group consisting of methyl, ethyl, 1-propyl, 2-propyl, 1-butyl, 2-butyl, 2-methyl-2-propyl, 2-methylpropyl, pentyl, 1,1-dimethylpropyl, 2,2-dimethylpropyl, 3-methylbutyl, 1-methylbutyl, 1-ethylpropyl, 1,2-methylpropyl and 2-methylbutyl ester of lysine.
4) The composition according to embodiment 1 (b), wherein the lipid removal enhancer is selected from the group consisting of methyl, ethyl, 1-propyl, 2-propyl, 1-butyl, 2-butyl, 2-methyl-2-propyl, 2-methylpropyl, pentyl, 1,1-dimethylpropyl, 2,2-dimethylpropyl, 3-methylbutyl, 1-methylbutyl, 1-ethylpropyl, 1,2-methylpropyl and 2-methylbutyl ester of arginine.
5) The composition according to embodiment 1 (b), wherein the lipid removal enhancer lysine.
6) The composition according to embodiment 1 (b), wherein the lipid removal enhancer is stearoyl lactylate.
7) The composition according to embodiment 1, wherein the detergent composition comprises on or more enzymes selected from the group consisting of lipases, proteases, peroxidases, cellulases, betaglucanases, xyloglucanases, hemicellulases, xanthanases, xanthan lyases, amylases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases (GH5 and/or GH26), licheninases, phosphodiesterases, pectin methylesterases, cellobiohydrolases, transglutaminases, nucleases, and combinations thereof, or any mixture thereof.
8) The composition according to embodiment 7 wherein the enzyme is lipase and/or protease.
9) Use of the detergent composition of any of embodiments 1 to 8 for cleaning a surface, such as a textile, comprising contacting the surface with the detergent composition.
10) A method for cleaning a surface, such as a textile, comprising contacting the surface with the detergent composition of any of embodiments 1 to 8.
11) The composition of embodiment 3, wherein the concentration of the lysine ester is adjusted to obtain a final concentration of the lysine ester in the wash liquor in the range of 0.5 mM to 20 mM, preferably the final concentration in the wash liquor is in the range of 1 mM to 10 mM.
12) The composition of embodiment 4, wherein the concentration of the arginine ester is adjusted to obtain a final concentration of the arginine ester in the wash liquor in the range of 0.5 mM to 20 mM, preferably the final concentration in the wash liquor is in the range of 1 mM to 10 mM.
13) The composition of embodiment 5, wherein the concentration of lysine is adjusted to obtain a final concentration of lysine in the wash liquor in the range of 0.5 mM to 20 mM, preferably the final concentration in the wash liquor is in the range of 1 mM to 10 mM.
14) The composition of embodiment 6, wherein the concentration of stearoyl lactylate is adjusted to obtain a final concentration of the stearoyl lactylate in the wash liquor corresponding to sodium stearoyl lactylate in the range of 100 ppm to 400 ppm, preferably the final concentration in the wash liquor corresponds to sodium stearoyl lactylate in the range of 100 ppm to 300 ppm.
15) The composition of embodiments 3 to 5 wherein lysine and arginine are in the L-form, the D-form or a mixture of L-form and D-form in any ratio.
16) The composition of embodiment 1 comprising more than one of the lipase removal enhancers.
17) The composition of any of embodiments 1 to 8 or 11 to 16 wherein no lipase is present.
18) Use of the composition of any of embodiments 1 to 8 or 11 to 17 for the improvement of the benefit-risk ratio of a detergent composition.
19) The composition of any of embodiments 1 to 8 and 11 to 16 or the use according to any of embodiments 9, 10 and 18, wherein the lipase, if any present, has at least 60%, such as at least 70%, 80%, 85%, 90%, 95% over even 100% sequence identity to any of the lipases of SEQ ID NO: 1 or SEQ ID NO: 2.

### EXAMPLES

### Materials and Methods

The following materials and methods have been used in the laundry experiments:

Lipase Activity Determined by p-Nitrophenyl (pNP) Assay

The hydrolytic activity of lipases may be determined by a kinetic assay using p-nitrophenyl acyl esters as substrate. A 100 mM stock solution in DMSO for each of the substrates p-nitrophenyl butyrate (C4), p-nitrophenyl caproate (C6), p-nitrophenyl caprate (C10), p-nitrophenyl laurate (C12) and p-nitrophenyl palmitate (C16) (all from Sigma-Aldrich Danmark A/S, Kirkebjerg Allé 84, 2605 Brøndby; Cat. no.: C3: N-9876, C6: N-0502, C10: N-0252, C12: N-2002, C16: N-2752) is diluted to a final concentration of 1 mM 25 mM in the assay buffer (50 mM Tris; pH 7.7; 0.4% Triton X 100). The lipase in 50 mM Hepes; pH 8.0; 10 ppm Triton X-100; +/−20 mM CaCl2 are added to the substrate solution in the following final protein concentrations: 0.01 mg/ml; 5×10 3 mg/ml; 2.5×10 4 mg/ml; and 1.25×10 4 mg/ml in 96-well NUNC plates (Cat. No. 260836, Kamstrupvej 90, DK-4000, Roskilde). Release of p-nitrophenol by hydrolysis of a p-nitrophenyl acyl may be monitored at 405 nm for 5 minutes in 10 second intervals on a Spectra max 190 (Molecular Devices GmbH, Bismarckring 39, 88400 Biberach an der Riss, GERMANY).

### Model Detergents

Two model detergents have been applied, one comprising LAS and one without LAS

TABLE 1
Model detergent I

| Compound | Content of compound (% w/w) |
|---|---|
| Sodium lauryl sulfate (SLS) | 2.5 |
| Sodium lauryl ether sulfate (SLES) | 8.5 |
| Coco soap | 4.3 |
| Alcohol ethoxylate (AEO, plant | 17 |
| derived | |
| H₂O, 6° dH | Add 100 |

TABLE 2
Model detergent II

| Compound | Content of compound (% w/w) |
|---|---|
| Linear alkylbenzenesulfonate (LAS) | 5 |
| Sodium lauryl ether sulfate (SLES) | 10 |
| alcohol sulfate (AS) | 5 |
| Coco soap | 1 |
| Alcohol ethoxylate | 5 |
| H₂O, 6° dH | Add 100 |

### Lipases

Lipase L1: Thermomyces lanuginosus lipase (TLL) shown in SEQ ID NO: 1 with the following substitutions: T231R+N233R (available from Novozymes A/S, Denmark)
Lipase LE2: Thermomyces lanuginosus lipase (TLL) shown in SEQ ID NO: 1 with the following substitutions: E1C+D27R+G38A+F51V+D96E+K98I+D111A+G163K+H198S+Y220F+T231R+N233C+D254S+P256T (available from Novozymes A/S, Denmark);
Lipase GCL1 is a lipase from Geotrichum candidum shown in SEQ ID NO: 2

### Textile

WFK80A, 5×5 cm, white or blue knitted cotton swatches (obtained from Warwick Equest Ltd, Unit 55, Consett Business Park, Consett, County Durham, DH8 6BN, United Kingdom)
CS-10 (butter fat) stains were obtained from Center for Test materials BV, P.O. Box 120, 3133 KT Vlaardingen, the Netherlands.

### Oil Swatches

Oil swatches was prepared by adding 25 μL pure coconut oil to a round piece of blue WFK80A textile with the diameter of 2 cm and dried before measuring weight with a balance and used for calculation of oil removal.

### Lard Swatches

For Mini-LOM-method: Lard swatches was prepared by melting and adding 25 μL pure lard to a round piece of blue WFK80A textile with the diameter of 2 cm and dried before measuring weight with a balance and used for calculation of lard removal.

For TOM: Lard swatches was prepared by melting and adding 100 μL pure lard to a 5×5 cm of blue WFK80A textile and dried before measuring weight with a balance and used for calculation of lard removal.

### CS-10 Swatches

For Mini-LOM-method: CS-10 swatches (CFT) were prepared as a punch-out from 5×5 cm normal swatch size to round piece of swatch with the diameter of 2 cm and used for odour measurements.

For TOM: CS-10 swatches (CFT) were used as 5×5 cm swatch size in wash and punched out to be used for odour measurements.

### Lipid Removal Enhancer

L-lysine methyl ester dihydrochloride (CAS No: 26348-70-9)
L-Arginine ethyl ester dihydrochloride (CAS No: 28696-31-3)
L-Arginine tert-butyl ester dihydrochloride (CAS No: 87553-73-9)
L-lysine (CAS No: 56-87-1)
L-arginine (CAS No: 1119-34-2)
Sodium stearoyl lactylate (CAS No: 25383-99-7)

For ease of reference the lipid removal enhancers may in the following be referred to as
Lysine methyl ester
Arginine ethyl ester
Arginine tert-butyl ester
Lysine
Arginine
SSL

### Wash Conditions Mini-LOM-Method, Standard Detergent Level

Wash liquor was prepared by dissolving 2.33 g Model detergent in 1 L of water with hardness 6° dH. 40 mL of the wash liquor was added to a 50 mL test tube.

Lipase and/or lipid removal enhancer was added to the wash liquor according to tables in the Examples to the wash liquor followed by adding 10 steel balls (diameter 5 mm) per tube and 4 oil swatches, 2 CS-10 swatches and 6 ballast swatches to the detergent.

The swatch addition was followed by continuous agitation at 40 rpm for 25 minutes at 20° C. Rinse was performed in a beaker under the tap applying cold water for 5 min.

After wash the swatches were dried on filter paper.

### Wash Conditions Mini-LOM-Method, Low Detergent Level

Wash liquor was prepared by dissolving 0.93 g Model detergent in 1 L of water with hardness 6° dH. 40 mL of the wash liquor was added to a 50 mL test tube.

Lipase and/or lipid removal enhancer was added to the wash liquor according to tables in the Examples to the wash liquor followed by adding 10 steel balls (diameter 5 mm) per tube and 4 oil swatches, 2 CS-10 swatches and 6 ballast swatches to the detergent.

The swatch addition was followed by continuous agitation at 40 rpm for 25 minutes at 20° C.

Rinse was performed in a beaker under the tap applying cold water for 5 min.

After wash the swatches were dried on filter paper.

### Wash Conditions Terg-o-Tometer (TOM) Assay

WFK80A 5×5 cm textile pieces were used as ballast. Lipase and enhancer was added according to the respective tables below in combination or separately followed by adding 4 oil or lard swatches and ballast pieces up to 30 g to the liquor mix. The swatch addition was followed by continuous agitation at 120 rpm for 15 minutes at 20° C. Rinse was performed in a beaker under the tap applying cold water for 5 min.

After wash the swatches were dried on filter paper.

### Oil Removal

Coconut oil swatches were dried 16 hours before weighing and oil removal was calculated based on subtracting weight of swatches after wash from weight before wash.

### Lard Removal

Lard swatches were dried 16 hours before weighing and lard removal was calculated based on subtracting weight of swatches after wash from weight before wash.

### Odour Measurement

CS-10 swatches were dried 16 hours and transferred to a Gas Chromatograph vial. After transfer the vial was closed.

The samples were incubated at 30° C. for 24 hours and subsequently heated to 140° C. for 30 minutes and stored at 20° C.-25° C. for at least 4 hours before analysis.

The analysis was performed on a Shimadzu Nexis GC-2030 equipped with a Carboxen PDMS SPME fiber (85 μm). Sampling from each GC vial was done at 50° C. for 8 minutes with the SPME fiber in the head-space over the textile pieces and the sampled compounds were subsequently injected onto the column (injector temperature=250° C.). Column flow=2 mL helium/minute. Column over temperature gradient: 1 minute=50° C., temp gradient with rate 38° C./min to end temp 240° C. Hold time 2.25 min. Detection was done using a Flame Ionization Detector (FID) and the retention time for butyric acid was identified using an authentic standard. The area of butyric acid peak was measured and compared to the area of the butyric acid peak obtained with lipase and no lipid removal enhancer.

### Example 1. Use of Lysine Methyl Ester and Lipase L1 for Lipid Removal, Standard Detergent Level (Mini-LOM)

The wash performance (oil removal and odour generation) of Lipase L1 and lysine methyl ester was measured according to the method with standard detergent level described above and the further conditions set out in Table 3 below:

TABLE 3
Use of lysine methyl ester for removal at standard detergent
level of lipid in combination with the lipase L1.

| | | Lysine | | Oil | +/− | Butyric acid peak | +/− |
|---|---|---|---|---|---|---|---|
| | Lipase L1 | methyl | | removal | SE | size normalized to | SE |
| Detergent | (0.15 ppm) | ester | | (%) | (%) | lipase alone (%) | (%) |
| Model I | − | − | | 16.9 | 1.3 | 3.4 | 0.2 |
| | + | − | | 27.7 | 1.2 | 100 | 2.7 |
| | − | 1 | mM | 29.4 | 1.0 | 5.0 | 0.4 |
| | + | 1 | mM | 42.5 | 1.0 | 94.2 | 2.5 |
| | − | 10 | mM | 50.2 | 0.8 | 5.1 | 0.7 |
| | + | 10 | mM | 66.7 | 0.4 | 83.5 | 1.1 |

It is evident that lysine methyl ester enhances the effect of the lipase having L1 and at the same time it surprisingly becomes evident that the same level of oil removal can be obtained with the use of 1 mM lysine methyl ester as with lipase but with significantly reduced odour generation, thus giving rise to an improved benefit-risk ratio.

It is further noticed that lipase in combination with lysine methyl ester decreases the formation of butyric acid and consequently improved benefit-risk ratio.

### Example 2. Use of Lysine Methyl Ester and Lipase GCL1 for Lipid Removal, Low Detergent Level (Mini-LOM)

The wash performance (oil removal and odour generation) of the Lipase GCL1 and lysine methyl ester was measured according to the method with low detergent level described above and the further conditions set out in Table 4 below:

TABLE 4
Use of lysine methyl ester for removal of lipid at low
detergent level in combination with the lipase GCL1.

| | Lipase | Lysine | Oil | +/− | Butyric acid peak | +/− |
|---|---|---|---|---|---|---|
| | GCL1 | methyl | removal | SE | size normalized to | SE |
| Detergent | (5 ppm) | ester | (%) | (%) | lipase alone (%) | (%) |
| Model I | − | − | 4.5 | 1.5 | 1.5 | 0.2 |
| | + | − | 7.0 | 5.1 | 100 | 3.7 |
| | − | 10 mM | 14.1 | 0.4 | 5.1 | 1.3 |
| | + | 10 mM | 26.2 | 1.0 | 117 | 4.8 |

It is evident that lysine methyl ester enhances the effect of the lipase GCL1 and at the same time it surprisingly becomes evident that a higher level of oil removal can be obtained with the use of 10 mM lysine methyl ester as with lipase but with significantly reduced odour generation, thus giving rise to an improved benefit-risk ratio.

It is further noticed that lipase in combination with lysine methyl ester does not change the level of formation of butyric acid compared to the use of lipase alone. But this should be seen in view of the fact that the oil removal is increased with a factor of almost 4. Consequently, an improved benefit-risk ratio is obtained.

### Example 3. Use of Arginine Ethyl Ester and Lipase GCL1 for Lipid Removal, Low Detergent Level (Mini-LOM)

The wash performance (oil removal and odour generation) of the lipase GCL1 and arginine ethyl ester was measured according to the method with low detergent level described above and the further conditions set out in Table 5 below:

TABLE 5
Use of arginine ethyl ester for removal of lipid at low
detergent level in combination with the lipase GCL1.

| | Lipase | Arginine | Oil | +/− | Butyric acid peak | +/− |
|---|---|---|---|---|---|---|
| | GCL1 | ethyl | removal | SE | size normalized to | SE |
| Detergent | (5 ppm) | ester | (%) | (%) | lipase alone (%) | (%) |
| Model I | − | − | 2.0 | 0.8 | 0 | 1.2 |
| | + | − | 4.5 | 1.1 | 100 | 4.0 |
| | − | 1 mM | 5.9 | 0.8 | 0 | 0.8 |
| | + | 1 mM | 10.9 | 0.8 | 145 | 17.9 |

It is evident that arginine-ethyl ester is compatible with the lipase GCL1 and that the effect of the lipase and the lipid removal enhancer is at least additive. At the same time, it surprisingly becomes evident that at least the same level of oil removal can be obtained with the use of 1 mM lysine methyl ester as with lipase but with significantly reduced odour generation, thus giving rise to an improved benefit-risk ratio.

### Example 4. Use of Arginine-Ethyl Ester and Lipases LE 1 and GCL1 for Lipid Removal, Low Detergent Level (Mini-LOM)

The wash performance (oil removal and odour generation) of the lipases L1 and GCL1 and arginine tert-butyl ester was measured according to the method with low detergent level described above and the further conditions set out in Table 6 below:

TABLE 6
Use of arginine tert-butyl ester for removal of lipid at low
detergent level in combination with the lipase LE 1 and GCL1.

| | | | | | Butyric acid | |
|---|---|---|---|---|---|---|
| | | | | | peak size | |
| | | | | | normalized to | |
| | | Arginine | Oil | +/− | respective | +/− |
| | | tert-butyl | removal | SE | lipase alone | SE |
| Detergent | Lipase | ester | (%) | (%) | (%) | (%) |
| Model I | − | − | 42.4 | 1.6 | 6.8 | 0.9 |
| | − | 1 mM | 59.4 | 1.4 | 6.9 | 0.6 |
| | − | 5 mM | 75.6 | 1.8 | 7.4 | 1.0 |
| | 5 ppm Lipase | − | 45.3 | 2.2 | 100 | 5.0 |
| | GCL1 | | | | | |
| | − | − | 42.4 | 1.6 | 5.1 | 0.9 |
| | − | 1 mM | 59.4 | 1.4 | 5.2 | 0.6 |
| | − | 5 mM | 75.6 | 1.8 | 5.6 | 1.0 |
| | 0.3 ppm Lipase | − | 62.7 | 1.3 | 100 | 3.2 |
| | L1 | | | | | |

Data shows that by addition of arginine tert-butyl ester the same level of oil removal can be gained as by use of lipases, but with significantly reduced odour generation, i.e. with increased benefit-risk ratio.

### Example 5. Use of Sodium Stearoyl Lactylate for Lipid Removal, Standard Detergent Level (TOM)

The wash performance (oil removal) of sodium stearoyl lactylate (SSL) was measured according to the method with standard detergent level described above and the further conditions set out in Table 7 below and compared to the use of lipase LE2:

TABLE 7
Use of SSL for removal of lipid at standard detergent level

| | | Sodium stearoyl | | |
|---|---|---|---|---|
| | Lipase LE2 | lactylate | Oil removal | +/− SE |
| Detergent | (ppm) | (200 ppm) | (%) | (%) |
| Model I | 0 | − | 21.5 | 0.6 |
| | 0.1 | − | 24.9 | 3.4 |
| | 0.2 | − | 26.6 | 1.6 |
| | 0.5 | − | 30.1 | 1.0 |
| | 1 | − | 35.7 | 2.9 |
| | 2 | − | 42.2 | 1.6 |
| | 0 | + | 36.5 | 1.7 |
| | 0.1 | + | 39.4 | 3.3 |
| | 0.2 | + | 38.7 | 4.2 |
| | 0.5 | + | 40.4 | 2.6 |
| | 1 | + | 48.4 | 5.2 |
| | 2 | + | 45.8 | 3.7 |

From the results above it is evident that the same level of oil removal can be obtained with SSL as with lipase.

### Example 6. Use of Lysine Methyl Ester and Lipase LE 1 for Oil Removal in Detergent II (0.8 g Detergent/L)

The wash performance (oil removal and odour generation) of the lipase L1 and lysine methyl ester was measured according to the Mini-LOM-method with 0.8 g detergent/L and the further conditions set out in Table 8 below:

TABLE 8
Use of lysine methyl ester with and without lipase L1 for oil removal

| | | Lysine | | Oil | +/− | Butyric acid peak | +/− |
|---|---|---|---|---|---|---|---|
| | Lipase L1 | methyl | | removal | SE | size normalized to | SE |
| Detergent | (0.15 ppm) | ester | | (%) | (%) | lipase alone (%) | (%) |
| Model II | − | − | | 24.1 | 2.3 | 5.5 | 1.7 |
| | + | − | | 34.4 | 2.2 | 100 | 3.2 |
| | − | 1 | mM | 32.0 | 1.5 | 5.2 | 1.5 |
| | + | 1 | mM | 55.1 | 1.8 | 111.9 | 2.7 |
| | − | 10 | mM | 58.2 | 1.6 | 4.0 | 0.5 |
| | + | 10 | mM | 68.7 | 0.7 | 146.0 | 3.6 |

From the results above it is evident that lysine methyl ester improves the removal oil both with and without the presence of lipase. Further, the use of lysine methyl ester alone allows for the same level of oil removal as lipase alone, but with a significantly improved benefit-risk ratio.

### Example 7. Use of Arginine Ethyl Ester for Lard Removal in Detergent II, Low Detergent Level

The wash performance (lard removal and odour generation) of the lipase LE 1 and arginine ethyl ester was measured according to the TOM-method with low detergent level described above and the further conditions set out in Table 9 below:

TABLE 9
Use of arginine ethyl ester for lard removal with and without lipase

| | | Arginine | | Lard | +/− | Butyric acid peak | +/− |
|---|---|---|---|---|---|---|---|
| | Lipase L1 | ethyl | | removal | SE | size normalized to | SE |
| Detergent | (0.1 ppm) | ester | | (%) | (%) | lipase alone (%) | (%) |
| Model II | − | − | | 22.2 | 0.2 | 0.4 | 0.1 |
| | + | − | | 30.0 | 0.5 | 100 | 9.9 |
| | − | 0.5 | mM | 30.9 | 0.4 | 0.5 | 0.2 |
| | + | 0.5 | mM | 38.5 | 0.5 | 105 | 9.3 |
| | − | 1 | mM | 33.6 | 0.5 | 0.8 | 0.5 |
| | + | 1 | mM | 41.5 | 0.6 | 102 | 3.5 |
| | − | 10 | mM | 36.9 | 0.5 | 1.7 | 1.0 |
| | + | 10 | mM | 38.1 | 0.3 | 102 | 5.6 |

From the results in Table 9 it is evident that arginine ethyl ester is capable of removing lard from the textile to the same extent as lipase but with an improved benefit-risk ratio.

### Example 8. Use of L-Lysine and Lipase GCL1 for Lipid Removal, Low Detergent Level

The wash performance (oil removal) of the GCL1 and lysine was measured according to the Mini-LOM-method with low detergent level described above and the further conditions set out in Table 10 below:

TABLE 10
Use of lysine for oil removal with and without lipase

| | Lipase GCL1 | | Oil removal | +/− SE |
|---|---|---|---|---|
| Detergent | (5 ppm) | Enhancer | (%) | (%) |
| Model II | − | — | 21.4 | 1.9 |
| | − | 10 mM L-lysine | 29.3 | 2.8 |
| | + | 10 mM L-lysine | 27.9 | 1.4 |

Results in Table 10 show that lysine can be used for removal oil from textile.

### Example 9. Use of L-Arginine and L-Arginine-Ethyl Ester and Lipase GCL1 for Lipid Removal, Low Detergent Level

The wash performance (oil removal) of the lipase GCL1 and arginine/arginine ethyl ester respectively was measured according to the Mini-LOM-method with low detergent level described above and the further conditions set out in Table 11 below:

TABLE 11
Use of arginine and arginine ethyl ester
for oil removal with and without lipase

| | Lipase | | | +/− |
|---|---|---|---|---|
| | GCL1 | | Oil | SE |
| Detergent | (5 ppm) | Enhancer | removal (%) | (%) |
| Model II | − | — | 21.4 | 1.9 |
| | − | 1 mM L-arginine | 20.3 | 1.9 |
| | + | 1 mM L-arginine | 20.9 | 0.9 |
| | − | 1 mM L-arginine-ethyl ester | 28.6 | 1.9 |
| | + | 1 mM L-arginine-ethyl ester | 35.2 | 2.0 |

Results in Table 11 show that arginine has no effect on the removal of oil from textile (same level as detergent without lipase/arginine), whereas arginine ethyl ester enhances the oil removal from textile.

1. A detergent composition comprising:
a. at least one detergent component;
b. a lipid removal enhancer selected from the group consisting of lysine, stearoyl lactylate, C₁ to C₅ ester of lysine and C₁ to C₅ ester of arginine
c. optionally one or more enzymes.

2. The composition according to claim 1, wherein the composition is a laundry detergent composition.

3. The composition according to claim 1(b), wherein the lipid removal enhancer is selected from the group consisting of methyl, ethyl, 1-propyl, 2-propyl, 1-butyl, 2-butyl, 2-methyl-2-propyl, 2-methylpropyl, pentyl, 1,1-dimethylpropyl, 2,2-dimethylpropyl, 3-methylbutyl, 1-methylbutyl, 1-ethylpropyl, 1,2-methylpropyl and 2-methylbutyl ester of lysine.

4. The composition according to claim 1(b), wherein the lipid removal enhancer is selected from the group consisting of methyl, ethyl, 1-propyl, 2-propyl, 1-butyl, 2-butyl, 2-methyl-2-propyl, 2-methylpropyl, pentyl, 1,1-dimethylpropyl, 2,2-dimethylpropyl, 3-methylbutyl, 1-methylbutyl, 1-ethylpropyl, 1,2-methylpropyl and 2-methylbutyl ester of arginine.

5. The composition according to claim 1(b), wherein the lipid removal enhancer is lysine.

6. The composition according to claim 1(b), wherein the lipid removal enhancer is stearoyl lactylate.

7. The composition according to claim 1, wherein the detergent composition comprises one or more enzymes selected from the group consisting of lipases, proteases, peroxidases, cellulases, betaglucanases, xyloglucanases, hemicellulases, xanthanases, xanthan lyases, amylases, acyl transferases, phospholipases, esterases, laccases, catalases, aryl esterases, amylases, alpha-amylases, glucoamylases, cutinases, pectinases, pectate lyases, keratinases, reductases, oxidases, phenoloxidases, lipoxygenases, ligninases, carrageenases, pullulanases, tannases, arabinosidases, hyaluronidases, chondroitinases, xyloglucanases, xylanases, pectin acetyl esterases, polygalacturonases, rhamnogalacturonases, other endo-beta-mannanases, exo-beta-mannanases (GH5 and/or GH26), licheninases, phosphodiesterases, pectin methylesterases, cellobiohydrolases, transglutaminases, nucleases, and combinations thereof, or any mixture thereof.

8. The composition according to claim 7 wherein the enzyme is lipase and/or protease.

9. (canceled)

10. A method for cleaning a surface, such as a textile, comprising contacting the surface with the detergent composition of claim 1.

11. The composition according to claim 3, wherein the concentration of lysine ester is adjusted to obtain a final concentration of the lysine ester in the wash liquor in the range of 0.5 mM to 20 mM, preferably the final concentration in the wash liquor is in the range of 1 mM to 10 mM.

12. The composition according to claim 4, wherein the concentration of arginine ester is adjusted to obtain a final concentration of the arginine ester in the wash liquor in the range of 0.5 mM to 20 mM, preferably the final concentration in the wash liquor is in the range of 1 mM to 10 mM.

13. The composition according to claim 5, wherein the concentration of lysine is adjusted to obtain a final concentration of the lysine in the wash liquor in the range of 0.5 mM to 20 mM, preferably the final concentration in the wash liquor is in the range of 1 mM to 10 mM.

14. The composition according to claim 6, wherein the concentration of stearoyl lactylate is adjusted to obtain a final concentration of the stearoyl lactylate in the wash liquor corresponding to sodium stearoyl lactylate in the range of 100 ppm to 400 ppm, preferably the final concentration in the wash liquor corresponds to sodium stearoyl lactylate in the range of 100 ppm to 300 ppm.

15. The composition according to claim 1, wherein the detergent composition comprises more than one lipid removal enhancer.

16. The method according to claim 10, wherein the detergent composition comprises more than one lipid removal enhancer.
